(19) United States
(12) Patent Application Publication
(10) Pub. No.: US 2026/0101098 A1
(43) Pub. Date: Apr. 9, 2026

(54) DISPLAY INTEGRATION EQUIPMENT

(71) Applicant: Iris Optronics Co., Ltd., Tainan City (TW)

(72) Inventors: Cheng Yu LIN, Kaohsiung City (TW); Cheng Hong YAO, Tainan City (TW); Chi Chang LIAO, Tainan City (TW)

(21) Appl. No.: 19/348,751

(22) Filed: Oct. 2, 2025

Related U.S. Application Data
(60) Provisional application No. 63/703,185, filed on Oct. 3, 2024.

(30) Foreign Application Priority Data
Sep. 10, 2025 (TW) 114134793

(51) Int. Cl. H04N 23/53; H04N 23/20; G02F 1/1343; G09G 3/36

(52) U.S. Cl. CPC H04N 23/53; H04N 23/20; G02F 1/13439; G09G 3/36; G09G 2380/10

(57) ABSTRACT

A display integration equipment includes a display device, a controller and at least one camera device. The display device includes a plurality of display modules and a light absorption module. The display modules include a liquid crystal layer. The light absorption module is disposed on a side of the display modules. The controller is signally connected to the display device, and the controller is configured to control the display device to display an image data. The camera device is disposed on a side of the light absorption module away from the display modules, the camera device is signally connected to the controller, and the camera device is configured to capture an image through the display device.

### RELATED APPLICATIONS

This application claims priority to US Provisional Application Serial Number 63/703,185, filed October 3, 2024 and Taiwan Application Serial Number 114134793, filed September 10, 2025, which are herein incorporated by references.

### BACKGROUND

### Technical Field

The present disclosure relates to an integration equipment. More particularly, the present disclosure relates to a display integration equipment with a camera device.

### Description of Related Art

According to the related data research, the human error accounts for 94%-96% of all automobile accidents, wherein the human error includes speeding, reckless driving, distracted driving, fatigue driving, drunk driving and the influence of drugs. Governments around the world are planning to adopt measures such as equipping with the driver monitoring system so as to warn the drivers at the appropriate time.

In addition to providing warnings, suppliers and automakers are going to connect the advanced driver assistance systems (ADAS) in the future so as to perform the assistance of the vehicle control or connect to the emergency services if the driver fails to react or is unable to react. Further, based on the technical basis of the driver monitoring system (DMS), the driver monitoring system can be expanded to the passenger monitoring system so as to analyze the behavior of the passengers for further connecting to every application of the intelligent cockpit, which is also a future development direction for the automakers and the suppliers.

An in-cabin monitoring system (ICMS) is an intelligent system which is used to monitor the in-vehicle environment, the driver status and the passenger behavior. ICMS is configured to combine multiple sensing techniques and artificial intelligence algorithms to improve the driving safety and the passenger comfort, and advance the development of the autonomous driving technology. ICMS is an important component of current ADAS systems.

However, most of the current ICMS cameras are exposed, and the driver sees the camera shooting him/her while driving. Owing to the camera faces towards the driver, the driver feels uncomfortable such as the perceived sense of surveillance and the leak of privacy. Hence, many drivers block the camera in purpose for avoiding the monitoring of the computer system, so that many car accidents have been caused by human error.

Some manufacturers in the industry have evaluated the application of organic light-emitting diode (OLED) or liquid crystal display (LCD) technologies for under display cameras (UDC). However, conventional OLED or LCD panels typically include an opaque thin-film transistor (TFT) metal layer and a black matrix (BM) on the color filter (CF) side. Further, the light transmittance is further reduced by the transmittance of the polarizer or the transmittance of the CF color resist, so that the transmittance is too low.

Therefore, there is a strong need in the industry for a display with high transmittance in the infrared (IR) wavelength range, which a camera can be disposed behind the display without affecting the performance of the display in the visible light range, and hence the related industries are seeking for the solutions thereof.

### SUMMARY

According to one aspect of the present disclosure, a display integration equipment includes a display device, a controller and at least one camera device. The display device includes a plurality of display modules and a light absorption module. The display modules include a liquid crystal layer. The light absorption module is disposed on a side of the display modules. The controller is signally connected to the display device, and the controller is configured to control the display device to display an image data. The camera device is disposed on a side of the light absorption module away from the display modules, the camera device is signally connected to the controller, and the camera device is configured to capture an image through the display device.

According to one aspect of the present disclosure, a display integration equipment includes a display device, a controller and at least one camera device. The display device includes a liquid crystal layer and a light absorption module. The liquid crystal layer includes a plurality of pixels. The light absorption module is disposed on a side of the liquid crystal layer. The controller is signally connected to the display device, and the controller is configured to control the display device to display an image data. The camera device is disposed on a side of the light absorption module away from the display device, the camera device is signally connected to the controller, and the camera device is configured to capture an image through the display device.

### BRIEF DESCRIPTION OF THE DRAWINGS

FIG. 1 is a schematic view of a display integration equipment according to the 1st example of the present disclosure.

FIG. 2 is a block diagram of the display integration equipment according to the 1st example.

FIG. 3 is an application diagram of the display integration equipment according to the 1st example.

FIG. 4A is a schematic view of the display device according to the 1st example.

FIG. 4B is a schematic view of a display device according to the 2nd example of the present disclosure.

FIG. 5 is a schematic view of a display integration equipment according to the 3rd example of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

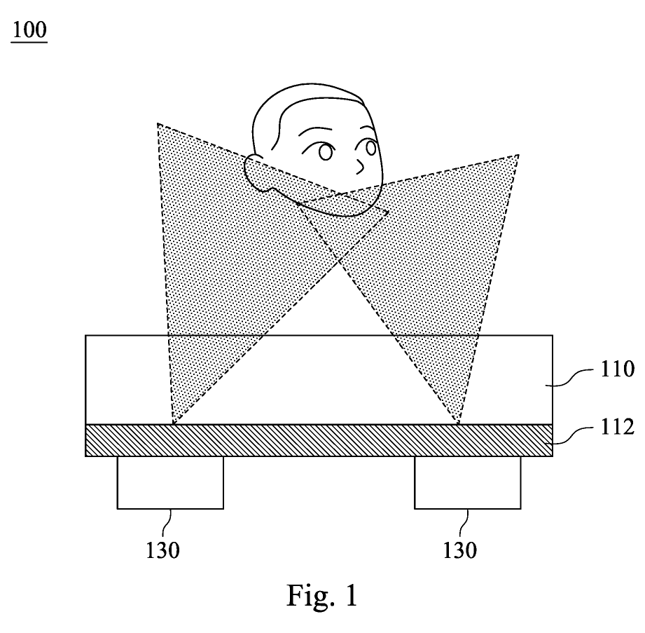

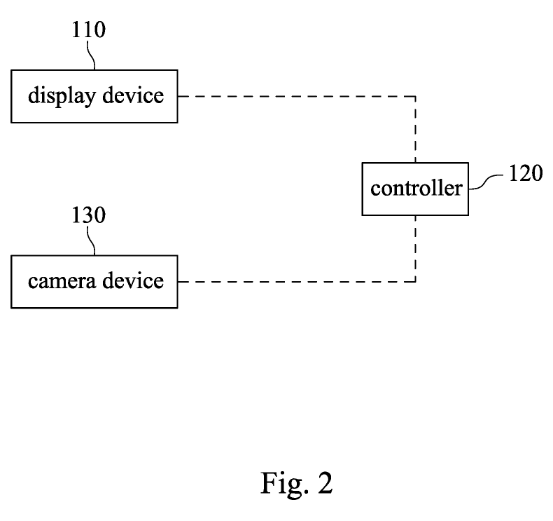

Please refer to FIGS. 1 and 2, wherein FIG. 1 is a schematic view of a display integration equipment according to the 1st example of the present disclosure; FIG. 2 is a block diagram of the display integration equipment according to the 1st example. The display integration equipment 100 includes a display device 110, a controller 120 and at least one camera device 130, wherein the controller 120 is signally connected to the display device 110, and the camera device 130 is disposed on a side of the display device 110.

According to the 1st example, the display device 110 can be a cholesteric liquid crystal display; the controller 120 can be a microprocessor, a central processing unit (CPU), a mobile device processor, a cloud processor or other electronic computing processors; the camera device 130 can be an infrared camera, a RGB camera or a 3D time of flight (ToF) camera, but the present disclosure is not limited thereto.

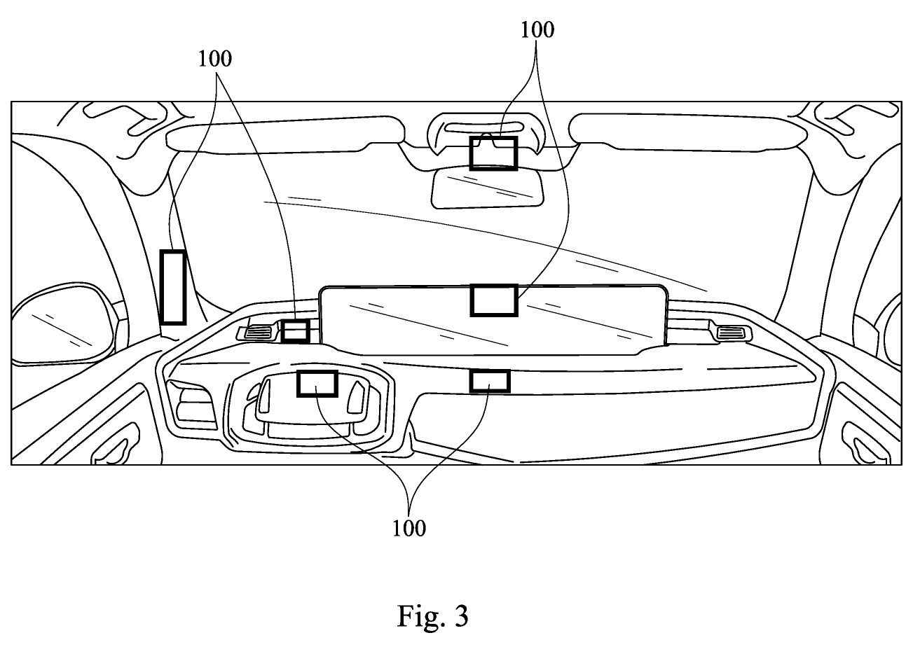

Please refer to FIG. 3, wherein FIG. 3 is an application diagram of the display integration equipment according to the 1st example. The display integration equipment 100 can be applied to ICMS, which is displayed in the way of the in-car display and configured to monitor the drivers or the passengers. Further, the display integration equipment 100 may not be presented by the in-car display. When the structure of the display integration equipment 100 is made of the flexible substrate such as polyethylene terephthalate (PET), so that the display integration equipment 100 can be also presented by the steering wheel skin or the car interior skin. Moreover, as shown in FIG. 3, the location of the display integration equipment 100 is flexible. In detail, the display integration equipment 100 can be disposed on the dashboard, the steering wheel, the A poles on the left side and the right side, the front side of the passenger seat or the interior rearview mirror (as the framed area in FIG. 3). In particular, when the display integration equipment 100 located on the steering post and the dashboard, which directly face towards the angle of the driver’s face, is most effective, followed by the A poles and the interior rearview mirror.

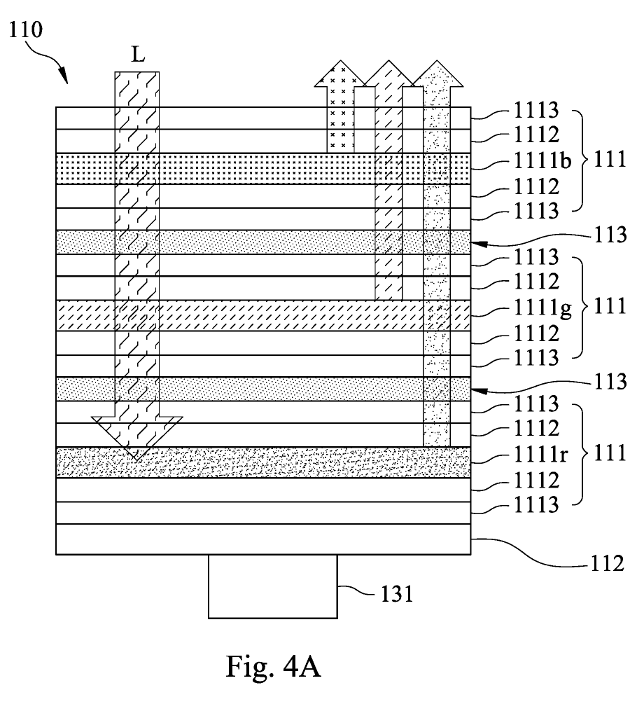

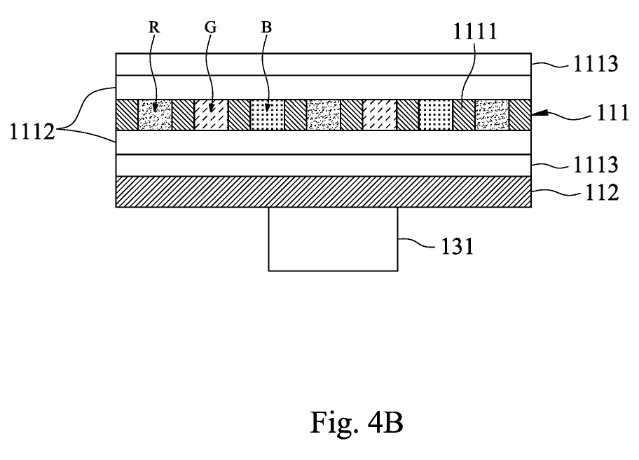

Please refer to FIGS. 1 and 4A, wherein FIG. 4A is a schematic view of the display device according to the 1st example. The display device 110 includes a plurality of display modules 111 and a light absorption module 112, and the light absorption module 112 is disposed on a side of the display modules 111. Further, the display device 110 can further include at least one optical adhesive layer 113 disposed between the display modules 111, and the optical adhesive layer 113 is configured to adhere the display modules 111. A transmittance of the display device 110 at an infrared wavelength range is larger than 15%.

The controller 120 is configured to control the display device 110 to display an image data. The camera device 130 is disposed on a side of the light absorption module 112 away from the display modules 111, the camera device 130 is signally connected to the controller 120, and the camera device 130 is configured to capture an image through the display device 110. The camera device 130 is the infrared camera so as to capture the face information and the eye information of the driver and the passengers under the low-light environment or the no-light environment. In detail, the infrared camera is crucial for the fatigue detection, the attention monitoring and the identity recognition. The camera device 130 is the RGB camera to capture the color image in the vehicle interior environment, and the camera device 130 is mainly configured to monitor the passenger’s behavior and recognize the in-vehicle status. The camera device 130 is the ToF depth camera configured to detect the passenger’s volume, posture and position, so that the number of the passengers can be identified and the erroneous movements on the seats can be prevented.

The display modules 111 are stacked, a visible light L can penetrate through the display modules 111 and the light absorption module 112 in sequence which are stacked to reach the camera device 130.

In FIG. 4A, a number of the display modules 111 is three, the three display modules 111 include a liquid crystal layer (as the liquid crystal layers 1111b, 1111g, 1111r which can reflect the blue light, the green light and the red light, respectively, in FIG. 4A), two transparent conductive layers 1112 and two protective layers 1113. The two transparent conductive layers 1112 of each of the display modules 111 are disposed on two surfaces of the liquid crystal layers 1111b, 1111g, 1111r, respectively. The two protective layers 1113 of each of the display modules 111 are disposed on two surfaces of the two transparent conductive layers 1112 away from the liquid crystal layers 1111b, 1111g, 1111r, respectively. According to the 1st example, the transparent conductive layers 1112 can be made of the transparent conductive material such as Indium-Tin-Oxide (ITO) or Indium-Zinc-Oxide (IZO); the protective layers 1113 can be made of the flexible transparent organic material such as glass, PET or polyimide (PI), but the present disclosure is not limited thereto.

The light absorption module 112 includes a light absorption layer configured to absorb a visible light L through the display modules 111, and the light absorption layer can be penetrated via the infrared light. The light absorbing layer can be made of the infrared penetrable material such as dye or coating, so that a lens 131 of the camera device 130 is directly disposed on the rear of the light absorption module 112 for capturing the image. Further, the infrared penetrable material can be the organic dye material such as bromine-substituted dye and nitro-substituted dye, the black organic dye such as based on aniline or phenothiazine or the polymer dye such as polyvinyl chloride dye. The infrared penetration efficiency of the light absorption layer can be enhanced while maintaining the inherent properties of the plastic material by adjusting the ratio of the different materials during the process.

It should be mentioned that the light absorption module can further include a substrate disposed on a side of the light absorbing layer to adhere the lens in other possible example. At this time, the light absorbing layer can be made of a dye-type infrared penetrable material, and the light absorbing layer can be formed by mixing the dye-type infrared penetrable material and the optical adhesive and then coating on the substrate. Further, in the other possible example, the light absorption module can further include an adhesive layer disposed on a side of the light absorbing layer, and the adhesive layer is adhered to the protective layer. The light absorbing layer can be formed by mixing the dye-type infrared penetrable material with the basic material such as the plastic material or the ABS (acrylonitrile butadiene styrene) resin.

Furthermore, when the display device 110 is the cholesteric liquid crystal display, the driving substrate of the cholesteric liquid crystal display only includes the transparent material such as ITO or PI in an active area (AA). Therefore, the material is close to transparent in both the visible light L and the IR bands, without the opaque element found in LCDs or OLEDs, such as CF, TFT and the polarizers. Further, the transmittance can be estimated to achieve 60% in 700 nm to 1000 nm band.

Moreover, the cholesteric liquid crystal display has higher transmittance in the IR bands than other displays, so that the camera device 130 is allowed to capture the image of the driver or the passengers through the display device 110 without affecting the normal display function of the display device 110.

Therefore, the display device 110 is the cholesteric liquid crystal display which can be penetrated via the infrared light, and the camera device 130 disposed behind thereof can be configured to capture the image outwards. Not only ensures the visual comfort of the driver, but ensures the effectiveness and the accuracy of the driver monitoring, so that the real-time monitoring of the vehicle driver can be achieved to promote the driving safety.

Please refer to FIG. 4B, wherein FIG. 4B is a schematic view of a display device according to the 2nd example of the present disclosure. The difference between the display device 110 according to the 2nd example and the display device 110 according to the aforementioned 1st example is that the display module 111 of the display device 110 has only one set (that is, the horizontal structure of the single-layer display). The liquid crystal layer 1111 of the display module 111 includes a plurality of pixels, and the pixels include a plurality of first pixels R, a plurality of second pixels G and a plurality of third pixels B, wherein the first pixels R are disposed at intervals, the second pixels G are disposed at intervals, the third pixels B are disposed at intervals, and the first pixels R, the second pixels G and the third pixels B are parallel disposed in sequence and configured to display different colors, respectively. In detail, the first pixels R, the second pixels G and the third pixels B can be configured to reflect the blue light, the green light and the red light, respectively.

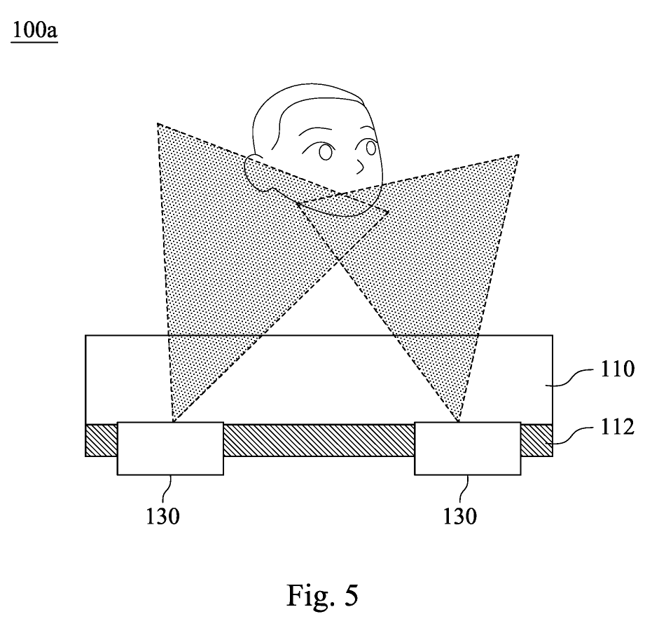

Please refer to FIG. 5, FIG. 5 is a schematic view of a display integration equipment according to the 3rd example of the present disclosure. According to the 3rd example, the difference between the display integration equipment 100a and the display integration equipment 100 according to the aforementioned 1st example is the disposition position of the camera device 130. In detail, the camera device 130 is disposed on at least one through hole of the light absorption module 112.

Further, the lens 131 of the camera device 130 of the display integration equipment 100a can be collocated of an anti-reflection (AR) coating for avoiding reflection, and the contrast of the display can be simultaneously increased.

In detail, owing to the reflection of the Fresnel, the light passes from the air through the glass substrate, which is not coated, every interface reflects about 4% of the light and only penetrates 92% of the incident light. The luminous flux is reduced via excessive of the reflecting light, the anti-reflection coating is attached on the surface of the lens, so that the luminous flux of the camera device 130 can be enhanced, the reflection and the scattering of the surface can be lowered, and the signal-to-noise ratio (SNR) of the camera device 130 can be effectively enhanced so as to make the image clearer.

In particular, the display device 110 can be penetrated via the infrared light, so that the camera device 130 disposed behind thereof can be configured to capture the image outwards. Not only ensures the visual comfort of the driver, but ensures the effectiveness and the accuracy of the driver monitoring, so that the real-time monitoring of the vehicle driver can be achieved to promote the driving safety.

It should be mentioned that the display integration equipment according to the present disclosure is not limited to ICMS, which is illustrated as example herein. In other examples, the display integration equipment can be applied to the e-books, unlocking the FACE ID system or monitoring the reader’s concentration and the abnormal posture to provide the timely rest suggestions.

Moreover, the display integration equipment can be also applied to the digital frame or the display screen in the hospital. Or, the display integration equipment can be assisted in the long-term care systems to monitor the patients for the abnormal physical conditions, such as falls and the abnormal posture. Further, the display integration equipment can be also the electronic advertising displays to determine the advertising content based on the viewer’s location, posture and gaze.

According to the aforementioned embodiment, the display integration equipment of the present disclosure has the following advantages. In particular, the display device is the cholesteric liquid crystal display which can be penetrated via the infrared light, so that the camera device disposed behind thereof can be configured to capture the image outwards. Not only ensures the visual comfort of the driver without affecting the display to normal display in the visible light bands, but ensures the effectiveness and the accuracy of the driver monitoring, so that the real-time monitoring of the vehicle driver can be achieved to promote the driving safety.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display integration equipment, comprising:
a display device, comprising:
a plurality of display modules comprising a liquid crystal layer; and
a light absorption module disposed on a side of the display modules;
a controller signally connected to the display device, and the controller configured to control the display device to display an image data; and
at least one camera device disposed on a side of the light absorption module away from the display modules, the at least one camera device signally connected to the controller, and the at least one camera device configured to capture an image through the display device.

2. The display integration equipment of claim 1, wherein a transmittance of each of the display modules at an infrared wavelength range is larger than 15%.

3. The display integration equipment of claim 1, wherein the at least one camera device is disposed on at least one through hole of the light absorption module.

4. The display integration equipment of claim 1, wherein the camera device is an infrared camera, and the display device is a cholesteric liquid crystal display.

5. The display integration equipment of claim 1, wherein each of the display modules further comprises:
two transparent conductive layers disposed on two surfaces of the liquid crystal layer, respectively; and
two protective layers disposed on two surfaces of the two transparent conductive layers away from the liquid crystal layer, respectively.

6. The display integration equipment of claim 1, wherein the light absorption module comprises:
a light absorption layer configured to absorb a visible light through the display modules;
wherein the light absorption layer is made of an infrared penetrable material.

7. The display integration equipment of claim 1, wherein the display modules are stacked, and the display modules are configured to display different colors, respectively.

8. A display integration equipment, comprising:
a display device, comprising:
a liquid crystal layer comprising a plurality of pixels; and
a light absorption module disposed on a side of the liquid crystal layer;
a controller signally connected to the display device, and the controller configured to control the display device to display an image data; and
at least one camera device disposed on a side of the light absorption module away from the display device, the at least one camera device signally connected to the controller, and the at least one camera device configured to capture an image through the display device.

9. The display integration equipment of claim 8, wherein the pixels comprise:
a plurality of first pixels disposed at intervals;
a plurality of second pixels disposed at intervals; and
a plurality of third pixels disposed at intervals;
wherein the first pixels, the second pixels and the third pixels are parallel disposed in sequence and configured to display different colors, respectively.

10. The display integration equipment of claim 8, wherein a transmittance of the liquid crystal layer at an infrared wavelength range is larger than 15%.

11. The display integration equipment of claim 8, wherein the at least one camera device is disposed on at least one through hole of the light absorption module.

12. The display integration equipment of claim 8, wherein the camera device is an infrared camera, and the display device is a cholesteric liquid crystal display.

13. The display integration equipment of claim 8, wherein the display device further comprises:
two transparent conductive layers disposed on two surfaces of the liquid crystal layer, respectively; and
two protective layers disposed on two surfaces of the two transparent conductive layers away from the liquid crystal layer, respectively.

14. The display integration equipment of claim 8, wherein the light absorption module comprises:
a light absorption layer configured to absorb a visible light through the liquid crystal layer;
wherein the light absorption layer is made of an infrared penetrable material.
